(19) United States
(12) Patent Application Publication
(10) Pub. No.: US 2006/0018795 A1
(43) Pub. Date: Jan. 26, 2006

(54) Fabrication methods and multifunctional substrate materials for chemical and biological analysis in microfluidic systems

(75) Inventors: Radislav Alexandrovich Potyrailo, Niskayuna, NY (US); Jeffrey Bernard Fortin, Niskayuna, NY (US); Andrew Michael Leach, Clifton Park, NY (US); Joshua Isaac Wright, East Greenbush, NY (US); Scott Boyette, New Hope, PA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/896,675

(22) Filed: Jul. 23, 2004

(51) Int. Cl. G01N 3/00

(52) U.S. Cl. 422/100

(57) ABSTRACT

Methods for making multifunctional microfluidic systems, and apparatuses prepared thereby are disclosed comprising an environmentally responsive component integrated into the substrate and exposed to the channels of a microfluidic chip.

### FIELD OF THE INVENTION

The present invention is directed to the field of microfluidic technology in general, and in particular, improved microfluidic structures and methods used to make the microfluidic structures to analyze a fluid stream for the presence of detectable compounds or conditions.

### BACKGROUND OF THE INVENTION

The field of microtechnology and microplates applied in micro-electro-mechanical systems (MEMS) technology has improved space economy in terms of laboratory miniaturization. Such advances have been achieved, in part, through the concepts of microfluidic chip technology's lab-on-chip (LOC), bio-MEMS, or micro-total analysis systems (μ-TAS). Such devices use chips having channels or reservoirs, or electrodes on their surface. Such chip technologies facilitate standard laboratory processes such as polymerase chain reactions, capillary electrophoresis, antibody tests, etc. In general, such technologies minimize the use of reagents and provide improved automation of fluidic analysis in the lab and in the field.

Fabrication of microfluidic systems involves multiple processing steps. It is well recognized from statistics and Six Sigma methodology that reduction of the number of fabrication steps may reduce the variability of the system and improve its performance. A typical microfluidic chip consists of at least two parts where a first part is a substrate and a second part is a microfabricated structure that contains microfluidic channels. Two such parts can both contain microfluidic components. Also, laminated microfluidic components are known that contain multiple layers that have different microfluidic components.

### SUMMARY OF THE INVENTION

A combination of multiple functional characteristics in a single material used for assembly of the microfluidic systems can be one of the approaches to reduce this number of steps in fabrication of microfluidic chips. The present invention is directed to a multifunctional microfluidic component and system, and method for its manufacture. The present invention contemplates a microfluidic substrate comprising a surface layer comprising an integrated environmentally responsive component. In one embodiment, the present invention is directed to a method for making a microfluidic system by providing a first microfluidic substrate having an integral environmentally responsive material. The responsive material may be incorporated into a coating material, with the coating material applied to a first microfluidic substrate surface. The coating itself comprises an integral environmentally responsive component. In a contemplated embodiment, the coated substrate is brought into contact with a second microfluidic substrate having an exposed channel, to form a microfluidic system. The coating material may also be an adhesive material impregnated with the environmentally responsive material.

In a further embodiment, the first or second substrate, or both, have an environmentally responsive component present throughout the substrate, or at least have the environmentally responsive component present at or near the channel surface. In yet another embodiment, the environmentally responsive component occurs integrally within an adhesive material layer that contacts one or both of the substrates such that the adhesive is interposed between the substrates. In such an orientation, at least a portion of the adhesive material layer is exposed to the channel and becomes a portion of the channel surface.

It is contemplated that the environmentally responsive material has a biological or chemical affinity to at least one compound, or is predictably reactive, such as a reduction or oxidation reaction, polymeric reaction, or a reaction able to emit a detectable signal (optical absorbance or emission, electrochemical, thermal, etc.). Ideally, the responsive material is selected to predictably interact with a specific analyte, enzyme, antibody, nucleic acid strands, or other chemically significant species.

Still further, the present invention contemplates an environmentally responsive component that can be released from the microfluidic substrate upon contact with a fluid, or alternatively react predictably with a fluid passed through the channel. Such reaction may have many purposes, including control of chemical composition of fluid flow propagating through the channel, or otherwise causing the dimension of the channel to predictably change to effect predictable and pre-determined internal flow pattern switching.

It is further contemplated that the present invention is directed to a microfluidic system comprising a first microfluidic substrate having a substrate surface. The substrate comprises an environmentally-responsive component. The system further comprises a second microfluidic substrate having a microfluidic channel having a channel surface and a channel volume, with the second substrate being in contact with the first microfluidic substrate, such that the microfluidic channel is bounded by the first substrate. In this way, at least a portion of the channel surface comprises the microfluidic substrate comprising the environmentally responsive component.

Yet, still further, the present invention is directed to a microfluidic system comprising a microfluidic substrate having a microfluidic channel having a channel surface, with the channel surface comprising an environmentally responsive component.

It is further contemplated that the present invention is directed to a microfluidic system comprising a combined microfluidic network that contains chemically and physically responsive coatings deposited over an extended length over a micro-channel that can both switch channel flow by swelling across a channel as by thermal or chemically responsive pattern, or that can restrict flow through a channel in response to the same stimulus. This later mechanism can be time-dependent where the coating slows or stops flow for a limited time by a swelling-dissolution mechanism along this responsive channel, or it can provide a backpressure mechanism that redirects flow through alternate channels. This design of chemically or environmentally-stimulated flow mechanisms creates a system that can direct system response according to the chemical properties of the entering fluid, e.g. a fluid below the response threshold will follow pattern A, while a fluid with properties above the triggering threshold will be directed into pattern B that contains an entirely different chemical process design, or by physical properties such as responsiveness to temperature or pH. This and similar designs can produce a “smart chip” that is capable of directing processing according to the nature of the entering sample without any electromechanical control response to said stimulus.

The present invention further contemplates a microfluidic system comprising a combined microfluidic network that swell to control flow across a chemically or physically responsive coating allowing the control of the reaction timing along this responsive channel. This added capability-allows a designed fluidic channel commonly configured to provide dimensional control of reaction timing to be further refined to provide kinetic control based on variations in the entering fluid. As a non-limiting example, a coating responsive to fluid pH could be coated on the channel and could swell proportional to the entering flow pH and provide altered flow that would control the reaction time in the channel. Similarly, a coating can be envisioned that dissolves or becomes more porous at a certain pH and increases the flow through the channel and results in a decrease in residence time in the channel and reduces the reaction time. It is further contemplated that the present invention is directed to a microfluidic system that combines the reaction timing and directional pattern in a combined pattern to provide a further embodiment of a chemically or physically responsive smart chip.

It is further contemplated that the present invention is directed to a microfluidic system where the chemically responsive film or channel coating is a material that, when exposed, produces a heat change that can alter the rate at which a reaction, physical change such as swelling or dissolution or similar response occurs in the fluidic channel. This process can be either exothermic or endothermic and provide potential thermal cycling along a channel without external heaters or coolers. A similar thermal control effect can be envisioned where the chemically-induced thermal effect can occur in a secondary channel immediately adjacent to the primary channel and induce the thermal change without having direct contact with the target fluid being manipulated in the primary channel.

All of these “smart-chip” platforms can be fabricated by coating all or partial regions of microfluidic system prior to final assembly. These coatings can be incorporated into an adhesion layer, or if compatible, coated on top of or underneath a suitable adhesion layer, either across the entire system or patterned along specific regions, and followed by a subsequent component adhesion to provide part or all of the functioning microfluidic system.

### BRIEF DESCRIPTION OF THE DRAWINGS

FIGS. 1A-1C show a cross-sectional view of a microfluidic system incorporating multifunctional substrate materials.

FIGS. 2A-2B show a cross-sectional view of an assembled microfluidic system.

FIGS. 3A-3 D illustrate one aspect of the present invention employing a bioaffinity agent to a microfluidic substrate surface.

FIGS. 4A-4D illustrate one aspect of the present invention employing enzymes to a microfluidic substrate surface.

FIGS. 5A and 5B illustrate the application of a chemically responsive substrate material capable of changing its physical size to restrict channel flow after reaction to a stimulus.

FIGS. 6A and 6B show an embodiment of the present invention where an environmentally responsive material (shown as shaded particles) is impregnated within a substrate that is then affixed to a substrate having channels.

FIGS. 7A and 7B are directed to an embodiment of the present invention where the substrate having the channels is impregnated with an environmentally responsive material.

FIGS. 8A-8D show an embodiment of the present invention where more than one layer having an environmentally responsive component impregnated therein.

FIG. 9 is a graph depicting chemical sensitivity of a multifunctional substrate material.

FIGS. 10A-10C and FIG. 11 are enlarged photographs of an assembled microfluidic system using fluorescence imaging.

FIG. 12 is a graph showing the fluorescence intensity upon exposure of the microfluidic system containing an aqueous solution of high pH.

### DETAILED DESCRIPTION OF THE INVENTION

This invention discloses materials for microfluidic substrates that have a multi-functionality. These materials serve not only as the means of solid support for the microfluidic structure but also serve as a chemically- and biologically-responsive material. This functionality is provided by several embodiments of this invention which include incorporating an environmentally-responsive group in the bulk and surface of substrate material, incorporating an environmentally-responsive group into a substrate layer that may or may not also serve as an adhesive layer to a microfluidic structure; and broadly fabricating a substrate material to contain environmentally-responsive groups for further processing into microfluidic structures.

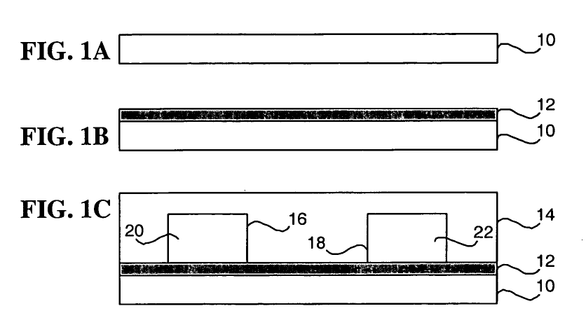

The fabrication steps of a microfluidic system that incorporates multifunctional substrate materials are depicted in FIGS. 1A-1C. As shown in FIG. 1A, a substrate material 10 is modified to contain environmentally-responsive groups. In one embodiment of the present invention, this modification is provided by incorporating environmentally-responsive groups into a separate layer that may also be an adhesive formulation used for bonding two components of a microfluidic chip. The incorporation of the responsive groups is preferably accomplished, for example, by surface modification of the substrate before bonding; by fabrication of the bulk substrate material that contains environmentally-responsive groups, etc. As shown in FIG. 1B, a multifunctional substrate is prepared by applying or adhering the environmentally-responsive adhesive layer 12 to the substrate material 10. As shown in FIG. 1C, a second substrate 14, such as a chip, containing microfluidic channels 16, 18 is bonded to the substrate. In this embodiment, the environmentally responsive material 12 of the substrate 10 is exposed to the interior of the microfluidic channels 20, 22. Examples of methods for fabricating the microfluidic chips with channels include photolithography, electron-beam lithography, micro-mechanical machining, ablation, and others known in the art.

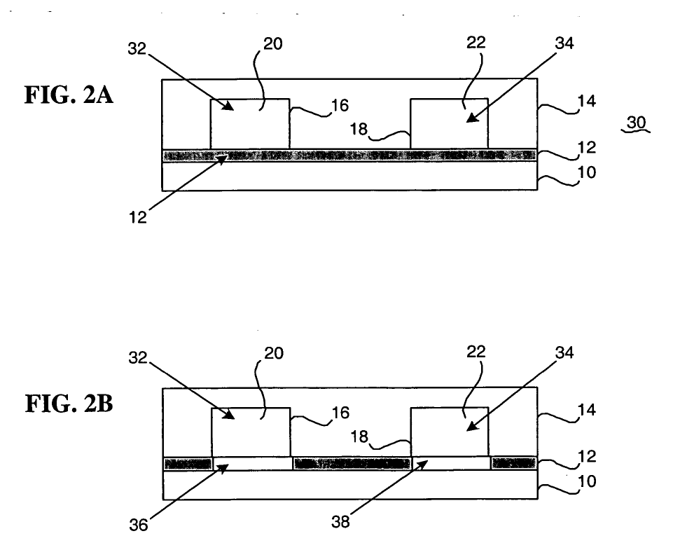

An operating principle of a microfluidic system of the present invention that incorporates multifunctional substrate materials is depicted in FIGS. 2A-2B. FIG. 2A shows, an assembled microfluidic chip 30 with two fluidic samples 32, 34 at an initial phase of fluidic operation prior to analyte fluid exposure. A multifunctional material 12 has as its initial property, for example, an optical property, or an adhesive function. FIG. 2B shows the assembled microfluidic chip of FIG. 2A with two fluidic samples at the measurement phase of fluidic operation where the multifunctional material 12 exhibits a measurable, or detectable change in its property that is evaluated over time. After a predetermined time (for example, less than a second as has been shown for certain sensor materials), the multifunctional substrate material 12 demonstrates a quantifiable and detectable change in its property 36, 38, which is related to the fluid nature (e.g. temperature, pH, etc.) and/or composition (e.g. the presence of targeted antibodies, enzymes, nucleic acids, aptazymes, aptamers, analytes, etc.).

In one embodiment, the environmentally responsive materials of the present invention have a chemical or biological affinity for one or more compounds or class of compounds. In one contemplated example, the biorecognition molecule is an immobilized antibody that can complex the desired target. This would allow additional processing to eliminate unwanted contaminants in the stream. Similarly, a second type of coating is contemplated that contains, for example, immobilized oligonucleotide base pairs that can be hybridized with specific nucleic acid strands, and then be post-processed to again eliminate unwanted contaminants. The systems of the present invention provide for targeted detection, extraction and purification in the microfluidic channel.

The present invention further contemplates exposing the channel and contents flowing therethrough to an impregnated substrate, or to a coating or coatings comprising environmentally responsive materials, such as the biorecognition molecules described above, with the additional feature that such biorecognition molecules can also be released from the coating or substrate surface in response to a predictable chemical or physical stimulus or treatment, post-purification, etc. and result in the release of the extracted material into a cleaner stream. The released molecules can exist at the substrate or coating surface in contact with the channel stream flow, or can be released into the channel stream flow for the purpose of detecting or reacting with a compound present in the stream flow.

In another embodiment, the biorecognition molecule is an antibody as described above, but one that can be used in a competitive binding assay to determine specific hapten concentration using any common, tagged immunoassay mechanism. Detection of the competitive assay could be performed using optical devices and transparent fluidic components, or the assay could use some other external detector that senses electromagnetic signals from the tag molecule. The systems of the present invention would also allow simultaneous antibody-based analyses in parallel streams, or in the same stream where sensing regions run serially. Antibodies can be developed for most hapten-like materials. Such materials can be small molecules like drugs or other biomolecules, or they can be larger molecules like treatment polymers. Similarly, secondary antibodies used in sandwich assays can bind to most proteins and can provide extraction capabilities as well as function in a sandwich-type bioassay.

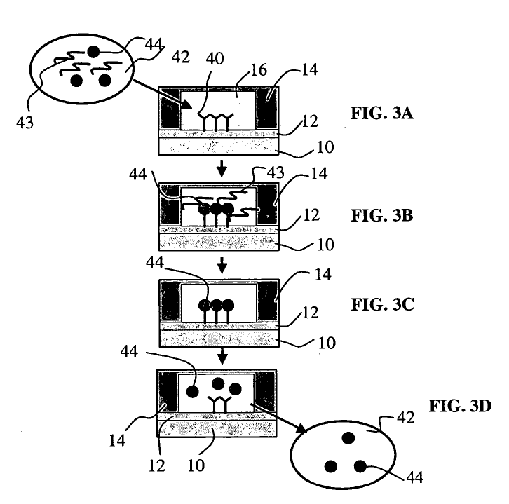

FIGS.3A-3D illustrate one contemplated aspect of the present invention where a microfluidic system incorporates a bioaffinity agent for sample conditioning or purification. These figures show an example of a targeted identification and removal step where contaminants are removed prior to affinity disruption. FIG. 3A shows the substrate 10 onto which has been affixed the environmentally responsive layer 12, said layer comprising bioaffinity agents 40. In an alternate embodiment not shown, the bioaffinity agent could be impregnated into the substrate 10 itself. Substrate 14, comprising channel 16, is shown bonded to environmentally responsive layer 12. A sample 42 is then introduced to channel 16. In FIG. 3B, the desired targets 44 in the sample 42 are bound to the bioaffinity agents 40. If purification or extraction of the target 44 from the mixture is desired as well as its identification, FIGS. 3C and 3D show the removal of the sample 42 and contaminants 43 from the channel 16 followed by effecting target 44 release from the bioaffinity agent 40 and removal from the channel 16.

In another embodiment, the bioaffinity agent could be a biorecognition molecule such as an antibody as described above, but one that could be used in a competitive binding assay to determine specific hapten concentration using any common tagged immunoassay mechanism, as would be readily apparent to one skilled in the immunoassay field. Detection of the competitive assay could be performed using optical devices and transparent fluidic components, or it could use some other external detector that senses electromagnetic or other signals from the tag molecule. The systems of the present invention also contemplate simultaneous antibody-based analysis, or analyses in parallel streams, or in the same stream where sensing regions run serially.

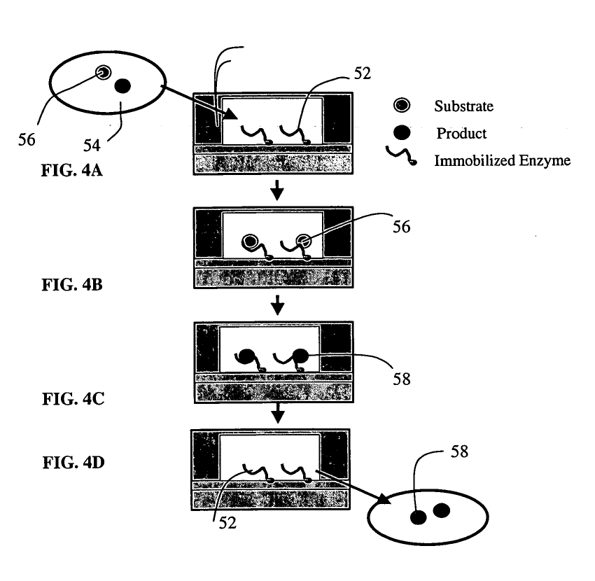

FIGS. 4A-4D show another contemplated aspect of the present invention. In this embodiment, the environmentally responsive coating material 12 contains an immobilized enzyme 52 that can catalyze specific reactions. In this embodiment, the analyte to be detected is either the substrate for a simple enzyme reaction, or has additional reactants in the stream that produce the desired enzyme catalyzed reaction. As shown in FIGS. 4A-4B a sample 54 containing reactant 56 is introduced to channel 16. The reactant 54 reacts with additional reactants in the fluid stream and is catalyzed by the enzyme 52 to produce product 58, (See FIG. 4C), which can then be removed from channel 16 (See FIG. 4D). The enzymatic processing can be used to create a signal reagent for quantitative analysis, or it can produce a reactant for a downstream process or reaction. Additional enzymes commonly used in ELISA assays (e.g. alkaline phosphates, horseradish peroxidase, etc.) could be used as solute or substrate indicators, and can be used in a fluorescence-based detection mechanism. Similarly, the immobilized reagent can contain an analyte or cofactor that stimulates a specific enzymatic reaction, and, in combination with additional detection schemes, can be used to detect specific enzymatic activity in a sample.

In another embodiment, the coating material could stimulate chemiluminescent or bioluminescent reactions in the stream. This design could be used to measure most light-emitting reactions by placing a photodetection device near the coated region. For example, the ATP enzyme is firefly luciferase. Acrydinium ester chemistry can be used with peroxide and caustic to create a chemiluminescent reaction. As stated above, the present invention also contemplates the presence of an environmentally responsive material incorporated directly into substrate 10 (e.g. via impregnation), potentially resulting in obviating the need for layer 12 if substrates 10 and 14 can be bonded without an adhesive layer, or allowing for the environmentally responsive material to migrate from its impregnated state in substrate 10 through layer 12.

In another embodiment, the material could be a chemically or physically responsive material that releases materials into the stream when either the chemical properties, e.g., pH or oxidation/reduction properties change, or that changes when the physical properties change, e.g., temperature changes stimulated by external heat sources, or heating or cooling created by endothermic or exothermic chemical reactions in the vicinity of the modified surface.

In another embodiment, the contemplated environmentally responsive material of the present invention can be processed in such a way as to exist as a physical barrier between channels at certain conditions, such as expanding or contracting under other conditions to either open or close a passage, predictably alter channel flow volume or flow rate, flow direction, or change flow through a complex fluidic pattern. Similarly, the material may dissolve or contract in such a way that it predictably opens an alternate passage, resulting in flow pattern switching. The present invention contemplates the use of a variety of material types to accomplish this function, including hydrogels, food gums and materials that provide a swellable material that, in turn, provides this channel volume altering (e.g. channel restricting or “closing”) property. Similarly, small molecular weight proteins, acrylic axcids or acrylamide matertials, and small molecular weight glycol materials (e.g. PEG, PPG, and copolymers) having limited solubility can dissolve and provide a channel opening activity.

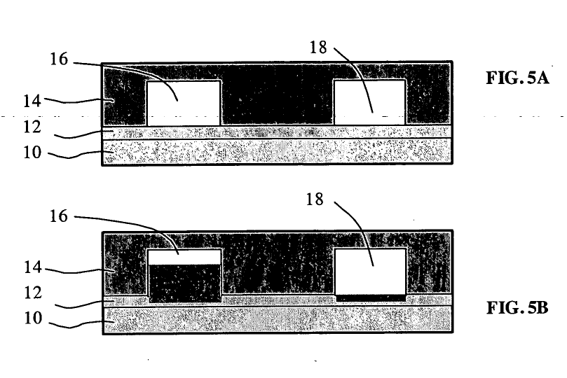

FIGS. 5A and 5B illustrate this aspect of the present invention whereby a device according to the present invention, as shown in FIG. 1C, incorporates, in its environmentally responsive layer 12, a chemically (pH) responsive material. FIG. 5A shows the microfluidic device before exposing the environmentally responsive layer 12 to a sample flowing through channels 16, 18. As shown in FIG. 5B as a sample is introduced to channel 16, the environmentally responsive material in layer 12 swells to diminish the volume of channel 16. By contrast, the same environmentally responsive material found in layer 12 does not react with the sample flowing through channel 18 having a low pH. Once again, the present invention also contemplates the presence of an environmentally responsive material incorporated directly into substrate 10 (e.g. via impregnation), potentially resulting in obviating the need for layer 12 if substrates 10and 14 can be bonded without an adhesive layer, or allowing for the environmentally responsive material to migrate from its impregnated state in substrate 10 through layer 12.

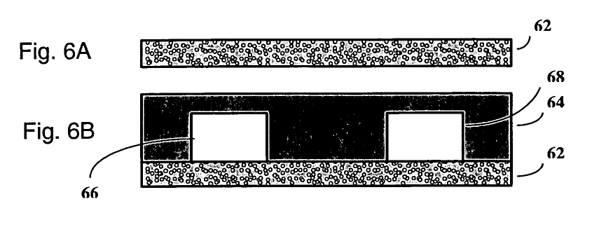

FIG. 6A shows an environmentally responsive component integrated within substrate 62. Substrate 62 may or may not have an adhesive layer used to affix it to substrate 64. In this embodiment of the present invention, the substrate comprising the environmentally responsive component contacts at least a portion of the channels 66, 68.

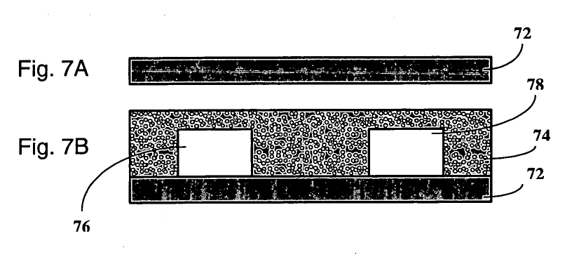

FIGS. 7A and 7B show a first substrate 72 adjoined to a second substrate compriseing channels and impregnated with an environmentally responsive component 74. In this way, the environmentally responsive component contacts channels 76, 78.

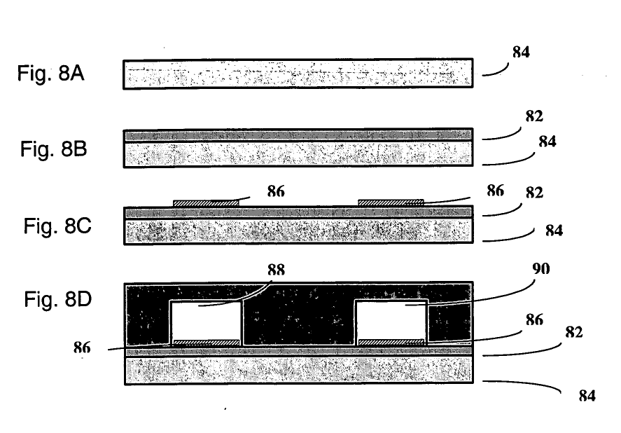

FIGS. 8A-8D show another embodiment of the present invention whereby an adhesive layer 82 is deposited onto a substrate 84, followed by deposition of an additional functional layer 86 where the functional layer pattern matches with the layout of the microfluidic channels 88, 90 in second substrate 92. FIG. 8C illustrates this embodiment.

Deposition of the functional layer is performed using any known techniques including micro spotting, ink jet printing, mechanical stamping, gravure, and any known methods as would be apparent to one skilled in the field. The aligned bonding of the substrate with the adhesive layer to the substrate with the microfluidic channels is further performed using standard techniques such as wafer bonding lamination equipment (e.g. wafer aligning and bonding tool, Karl Suss).

The present invention also contemplates coating a portion, or the entirety of the microfluidic channel with the same multifunctional environmentally responsive material, such that 100% of the structure is coated with responsive material. Another contemplated embodiment involves coating the upper substrate (the substrate comprising the channels) with the multifunctional material.

The adhesive could be UV or thermally cured. Also various “permanent” tapes could be used to laminate over the top of the channels, for example those produced by 3M Company. Further contemplated options include spinning an adhesive onto the channels substrate and ablating the adhesive in the channels with a laser before lamination.

Still further, the present invention contemplates the use of multiple layers or coatings whereby the environmentally responsive material is present in one or more layers that may or may not be in direct contact with the channel surface. In such instances, it is contemplated that a required concentration of environmentally responsive material will predictably migrate, as necessary, through the “over-coating” layers to the channel (such layers being predictably permeable as necessary).

### EXAMPLES

Experimental demonstrations of the concept of the multifunctional substrate materials for microfluidic applications were performed by chemically modifying a polymeric substrate material that was used for bonding to a microfluidic chip and evaluation properties of fluids in the microfluidic system.

Evaluation of optical properties of the substrate material was done using a fiber-optic system that included a 532-nm laser light source and a portable spectrometer (Ocean Optics, Inc., Model ST2000). The spectrometer was equipped with a 600-grooves/mm grating blazed at 400 nm and a linear CCD-array detector. The spectrometer covered the spectral range from 250 to 800 nm with efficiency greater than 30%. Light from the lamp was focused into one of the arms of a “six-around-one” bifurcated fiber-optic reflection probe (Ocean Optics, Inc., Model R400-7-UV/VIS). The common arm of the probe illuminated the material at a small angle relative to the normal to the surface. The second arm of the probe was coupled to the spectrometer.

Evaluation of assembled microfluidic chip with the new substrate material was done using an imaging system that included a 532-nm laser light source, a beam expander for the efficient illumination of the microfluidic chip, and a cooled CCD camera (Roper Scientific, Trenton, N.J., Model TE/CCD 1100 PF/UV). Fluorescence images were collected through a 570-nm long pass optical filter. Image analysis was performed using a software provided with the CCD camera.

Deposition and bonding of the photoresist was accomplished using SU-8 as an epoxy-based photoresist. SU-8 is an epoxy-based negative photoresist that becomes cross-linked when processed. This renders it insoluble to liquid developers and very applicable for permanent devices. SU-8 photoresist is typically applied to substrates via spin coating and can be up to hundreds of micrometers in thickness. A lithography tool is used to expose selected areas of the SU-8 to UV light. These areas undergo chemical modification and become very chemically resistive solid structures. The areas that are not exposed to light can be washed away in a subsequent step. SU-8 has high optical transparency above 350 nm and this allows any photolithography of the material to achieve almost vertical sidewalls. SU-8 can be deposited onto Si, glass, sapphire, or any number of substrate types

With this optical transparency, a single spin coating of the SU-8 up to 350 μm can be patterned and resolved using classic lithography techniques. SU-8 processing involves the following steps: 1—Cleaning of the substrate (in our case glass) 2—Spin coating the SU-8 onto the substrate (˜130 μm@2000 rpm for 30 sec) 3—Softbake—bake off some of the solvents 4—Expose through quartz mask (UV flood expose—contains all wavelengths) 5—Post Expose Bake—finishes the cross linking of the material. 6—Develop—removes any uncross linked material (unexposed)

The exposure dose (step 4) has the greatest impact on material adhesion to the substrate (glass), this is coupled to the other bakes but it is much more sensitive than any other variable. The “top” lamination can be attempted in various ways. First by using a thermally cured adhesive under pressure. Second, using a UV cured adhesive after applying lamination pressure. Third using adhesives at room temperature. Fourth, using permanent tape over the channels.

### Example 1

Evaluation of Optical Properties of the Substrate Material

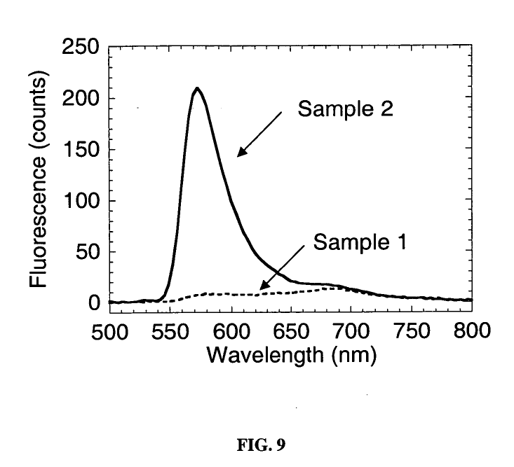

Chemical sensitivity of the multifunctional substrate material was evaluated by its spectroscopic response to samples of different nature. Results of these measurements are presented in FIG. 9. Sample 1, aqueous solution of low pH. Sample 2, aqueous solution of high pH.

Experimental demonstrations of the concept of the multifunctional substrate materials for microfluidic applications were performed by chemically modifying a polymeric substrate material that was used for bonding to a microfluidic chip and evaluation properties of fluids in the microfluidic sustem.

Deposition and bonding of photoresist was accomplished using SU-8 as an epoxy-based photoresist. SU-8 is an epoxy-based negative photoresist that becomes very cross linked when processed. This renders it insoluble to liquid developers and very applicable for permanent devices. SU-8 photoresist is typically applied to substrates via spin coating and can be up to hundreds of micrometers in thickness. A lithography tool is used to expose selected areas of the SU-8 to UV light. These areas undergo chemical modification and become very chemically resistive solid structures. The areas that are not exposed to light can be washed away in a subsequent step. SU-8 has high optical transparency above 350 nm and this allows any photolithography of the material to achieve almost vertical sidewalls. SU-8 can be deposited onto Si, glass, sapphire, or any number of substrate types.

With this optical transparency, a single spin coating of the SU-8 up to 350 μm can still be patterned and resolved using classic lithography techniques. SU-8 processing involves the following steps:
7—Cleaning of the substrate (in our case glass)
8—Spin coating the Su-8 onto the substrate (˜130 μ@2000 rpm for 30 sec)
9—Softbake—bake off some of the solvents
10—Expose through quartz mask ( UV flood expose—contains all wavelengths)
11—Post Expose Bake—finishes the cross linking of the material.
12—Develop—removes any uncross linked material (unexposed)

The exposure dose (step 4) has the greatest impact on material adhesion to the substrate (glass), this is coupled to the other bakes but it is much more sensitive than any other variable. The “top” lamination can be attempted in various ways. First by using a thermally cured adhesive under pressure. Second, using a UV cured adhesive after applying lamination pressure. Third using adhesives at room temperature. Fourth, using permanent tape over the channels.

Evaluation of optical properties of the substrate material was done using a fiber-optic system that included a 532-nm laser light source and a portable spectrometer (Ocean Optics, Inc., Model ST2000). The spectrometer was equipped with a 600-grooves/mm grating blazed at 400 nm and a linear CCD-array detector. The spectrometer covered the spectral range from 250 to 800 nm with efficiency greater than 30%. Light from the lamp was focused into one of the arms of a “six-around-one” bifurcated fiber-optic reflection probe (Ocean Optics, Inc., Model R400-7-UV/VIS). The common arm of the probe illuminated the material at a small angle relative to the normal to the surface. The second arm of the probe was coupled to the spectrometer.

### Example 2

Evaluation of Assembled Microfluidic Chip with the New Substrate Material

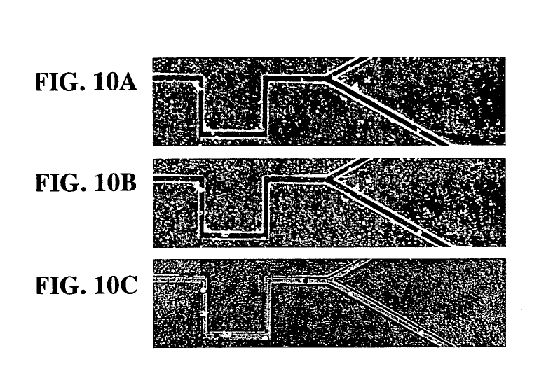

An evaluation of an assembled microfluidic chip with the new substrate material using fluorescence imaging was performed. The imaging system included a 532 nm laser light source, a beam expander for the efficient illumination of the microfluidic chip, and a cooled CCD camera (Roper Scientific, Trenton, N.J., Model TE/CCD 1100 PF/UV). Fluorescence images were collected through a 570 nm long pass optical filter. Image analysis was performed using a software provided with the CCD camera software. Results are presented in FIGS. 10A-10C. First, a fluorescence image of the microfluidic chip with Sample 1 (aqueous solution of low pH) was collected (FIG. 10A). Next, a fluorescence image of the microfluidic chip with Sample 2 (aqueous solution of high pH) was obtained (FIG. 10B). The difference of these two images contains the quantitative information about the fluorescence property of the substrate material in contact with the microchannels. As shown in FIG. 10C, the difference between two images demonstrates an increase in fluorescence intensity in microchannels.

FIGS. 10A-10C show an evaluation of assembled microfluidic chip with the new substrate material using fluorescence imaging. FIG. 10A shows the fluorescence image of the microfluidic chip with Sample S1 (aqueous solution of low pH). FIG. 10B shows the fluorescence image of the microfluidic chip with Sample 2 (aqueous solution of high pH). FIG. 10C shows the difference between two images demonstrating an increase in fluorescence intensity in microchannels. The channel width was measured at 200 micrometers.

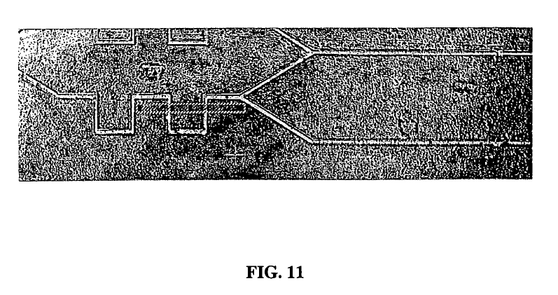

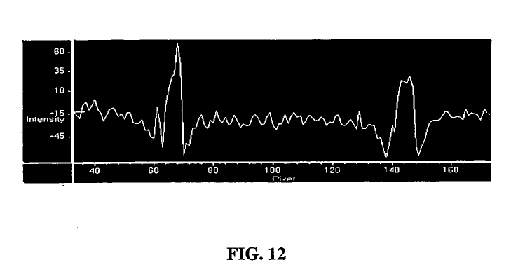

Quantitative results of the fluorescence enhancement were obtained further by taking a cross section of two channels (see FIG. 11). A cross section of the outlined region demonstrates the increase in fluorescence intensity upon exposure of the microfluidic chip material to sample 2 (aqueous solution of high pH). This data is depicted in FIG. 12.

FIG. 11 shows an evaluation of assembled microfluidic chip with the new substrate material using fluorescence imaging. The white-lined box is a region of interest for detailed quantitative analysis.

FIG. 12 shows an evaluation of assembled microfluidic chip with the new substrate material using fluorescence imaging. Cross section of the region from FIG. 5 that demonstrates the increase in fluorescence intensity upon exposure of the microfluidic chip material to sample 2 (aqueous solution of high pH).

The preceding description and accompanying drawings are intended to be illustrative of the invention and limiting. Various other modifications and applications will be apparent to those skilled in the art without departing from the spirit and scope of the invention as defined by the following claims.

We claim:

1. A method for making a microfluidic system comprising the steps of:
providing a first microfluidic substrate comprising an environmentally responsive component;
providing a second microfluidic substrate; and
adjoining the first and second substrates.

2. A method for making a microfluidic system comprising the steps of:
providing a first microfluidic substrate;
providing a first coating material to the first microfluidic substrate, said coating material comprising an environmentally-responsive component;
applying the first coating material to the first microfluidic substrate. providing a second microfluidic substrate; and
applying the first microfluidic substrate to the second microfluidic substrate to produce the microfluidic system.

3. The method according to claim 1, wherein at least one of the microfluidic substrates comprises a channel having a channel surface and channel volume.

4. The method according to claim 2, wherein at least one of the microfluidic substrates comprises a channel having a channel surface and channel volume.

5. The method of claim 3, wherein at least a portion of the channel surface comprises the microfluidic substrate comprising the environmentally responsive component.

6. The method of claim 1, wherein the environmentally responsive component has a biological or chemical affinity to at least one compound.

7. The method of claim 1, wherein the environmentally responsive component is predictably reactive.

8. The method of claim 1, wherein the environmentally responsive component comprises at least one compound that is predictably released from the coating material.

9. The method of claim 1, wherein the environmentally responsive component comprises at least one compound that reacts in response to a stimulus selected from the group consisting of temperature, pressure, pH, and presence of a pre-selected component.

10. The method of claim 1, wherein the coating material comprises an adhesive material.

11. The method of claim 2, wherein the coating material further comprises an adhesive material.

12. The method of claim 1, wherein the environmentally responsive component comprises a compound selected from the group consisting of antibodies, enzymes, nucleic acids, aptazymes and aptamers.

13. The method of claim 1, wherein the environmentally responsive component detectably reacts with a pre-selected compound.

14. The method of claim 13, wherein the environmentally responsive component detectably reacts with a compound to fluoresce.

15. The method of claim 1, wherein the environmentally responsive component reacts to effect a detectable heat change.

16. The method of claim 1, wherein the environmentally responsive material reacts with a compound to effect a change in the channel volume.

17. The method of claim 1, further comprising the steps of providing and applying a second coating material over the first coating material.

18. A microfluidic system comprising:
a first microfluidic substrate comprising an environmentally responsive component; and
a second microfluidic substrate adjoined to the first microfluidic substrate.

19. A microfluidic system comprising:
a first microfluidic substrate having a substrate surface;
a coating material applied to the first microfluidic substrate surface, said coating material comprising an environmentally-responsive component; and
a second microfluidic substrate adjoining the coating material applied to the first microfluidic substrate surface.

20. The microfluidic system of claim 18 wherein at least one of the microfluidic substrates comprises a channel having a channel surface and channel volume.

21. The microfluidic system of claim 19, wherein at least one of the microfluidic substrates comprises a channel having a channel surface and channel volume.

22. The microfluidic system of claim 20, wherein at least a portion of the channel surface comprises the microfluidic substrate comprising the environmentally responsive component.

23. The microfluidic system of claim 21, wherein at least a portion of the channel surface comprises the microfluidic substrate comprising the environmentally responsive component.

24. The microfluidic system of claim 18, wherein the environmentally responsive material has a biological or chemical affinity to at least one compound.

25. The microfluidic system of claim 18, wherein the environmentally responsive material is predictably reactive.

26. The microfluidic system of claim 18, wherein the environmentally responsive material comprises at least one compound that is predictably released from the coating material.

27. The microfluidic system of claim 18, further comprising an adhesive layer.

28. The microfluidic system of claim 19, wherein the coating material comprises an adhesive.

29. The microfluidic system of claim 27, wherein the adhesive layer comprises an integral environmentally responsive component.

30. The microfluidic system of claim 16, wherein the environmentally responsive component comprises at least one compound that is predictably released from the coating material in response to a stimulus selected from the group consisting of temperature, pH, presence of a pre-selected component.

31. The microfluidic system of claim 18, wherein the environmentally responsive component comprises a compound selected from the group consisting of antibodies, enzymes, nucleic acids, aptazymes and aptamers.

32. The microfluidic system of claim 18, wherein the environmentally responsive component detectably reacts with a compound.

33. The microfluidic system of claim 18, wherein the environmentally responsive component reacts with a compound to fluoresce.

34. The microfluidic system of claim 18, wherein the environmentally responsive component reacts to effect a detectable heat change.

35. The microfluidic system of claim 18, wherein the environmentally responsive material reacts to effect a change in the channel volume.

36. A microfluidic substrate comprising an adhesive, said adhesive comprising an integrated environmentally responsive component.

37. A microfluidic chip comprising:
a first microfluidic substrate having a channel surface; and
a second microfluidic substrate having a microfluidic channel having a channel surface, wherein at least one of said first and second substrates comprises an environmentally responsive component, and wherein the environmentally responsive component affects a through-flow of a flow in the channel.

38. A microfluidic chip comprising:
a first microfluidic substrate having a substrate surface;
a coating material applied to the first microfluidic substrate surface, said coating material comprising an environmentally-responsive component; and
a second substrate affixed to the first substrate, with at least one substrate having a channel, wherein the environmentally responsive component affects a through-flow of a flow in the channel.

39. The microfluidic chip of claim 37, wherein the environmentally responsive component affects a through-flow of a flow in the channel without a electromechanical control response to a stimulus.

40. The microfluidic chip of claim 38, wherein the environmentally responsive component affects a through-flow rate of a flow in the channel without an electromechanical control response to a stimulus.

41. The microfluidic chip of claim 37, further comprising an adhesive layer.

42. The microfluidic chip of claim 38, wherein the coating material comprises an adhesive.
